(19) United States
(12) Patent Application Publication
(10) Pub. No.: US 2008/0012331 A1
(43) Pub. Date: Jan. 17, 2008

(54) Quiet gas connector

(75) Inventors: Michael T. Angus, Derry, PA (US); Michael T. Lyon, Pittsburgh, PA (US)

Correspondence Address: EDWARDS ANGELL PALMER & DODGE LLP, P.O. BOX 55874, BOSTON, MA, 02205, US

(73) Assignee: Dormont Manufacturing Company, Export, PA (US)

(21) Appl. No.: 11/707,841

(22) Filed: Feb. 16, 2007

Related U.S. Application Data
(60) Provisional application No. 60/777,806, filed on Mar. 1, 2006.

(51) Int. Cl. F16L 25/00

(52) U.S. Cl. 285/386

(57) ABSTRACT

A gas connector having a tube with corrugations of uniform height and thickness, wherein the corrugations form successively repeating patterns comprising a first segment of non-compressed corrugations and a second segment of axially compressed corrugations. The gas connector eliminates or greatly reduces whistling noises when conveying a gas.

### CROSS-REFERENCE TO RELATED APPLICATION

This application claims priority to U.S. Provisional patent application Ser. No. 60/777,806, filed Mar. 1, 2006, which is incorporated herein by reference.

### BACKGROUND OF THE DISCLOSURE

1. Field of the Disclosure

The present disclosure is related to corrugated tubing and, more particularly, to flexible stainless steel corrugated hoses for conveyance of gases.

2. Background of the Related Art

Many appliances utilize fuel such as natural gas or propane, which is delivered to the appliances through rigid pipe or flexible connectors. For example, cooking ranges, clothes dryers, water heaters, space heaters, pool heaters, furnaces, gas meters and automatic hearths are supplied with natual gas or propane from a utility supply or storage tank. The flexible connectors may be smooth or corregated. Corregated connectors are normally preferred since the corregations provide flexibility and strength without an increased thickness in the sidewall of the connector.

Under certain conditions of pressure drop and/or high flow rate, typical flexible stainless steel corrugated hoses generate a whistling noise while conveying gases such as natural gas, propane, and air. In many instances, the whistling noise derives from turbulence within the hoses. In applications such as gas logs for artificial fireplaces, the whistling noise is highly undesirable. As a result, manufacturers of such systems recommend against the use of flexible corrugated hoses. Generally, it is undesirable to have a whistling noise generated by gas connectors because the whistling undesirably generates reactions from annoyance and discomfort to concerns about leaks.

What is desired is a new and improved corregated gas connector that is quiet while conveying gases yet still flexible in order to be conveniently applied to any application.

### SUMMARY OF THE DISCLOSURE

The present disclosure provides a gas connector including a tube having corrugations of uniform height and thickness, wherein the corrugations form successively repeating patterns comprising a first segment of non-compressed corrugations and a second segment of axially compressed corrugations. Among other features and benefits, a gas connector constructed in accordance with the present disclosure has been found to eliminate or greatly reduce whistling noises when conveying a gas.

In another embodiment, a quiet connector for conveying fluid includes a corrugated tube having a first end and a second end, wherein the corrugated tube has at least one segment that is formed and configured to disrupt noise-generating turbulence therein. Each end of the tube is configured to couple the tube in a fluidic system. Preferably, the at least one segment includes corregations that have been axially compressed.

In still another embodiment, the subject disclosure is directed to method for fabricating a quiet gas connector including the steps of forming corrugations in a length of tube and axially compressing a portion of the corrugations using a die. A flare nut may be attached to each end of the tube. The axially compressing step may be repeated a plurality of times to form a repeating pattern of a segment of non-compressed corrugations and a segment of compressed corrugations. One or more different dies may be used to compress different numbers of corrugations.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Reference is made to the attached drawings, wherein elements having the same reference character designations represent like elements throughout, and wherein:

FIG. 1 is a side elevation view of an exemplary embodiment of a gas connector having flare nut connection ends in accordance with the present disclosure;

FIG. 2 is a side elevation view of another exemplary embodiment of a gas connector constructed having compression connection ends in accordance with the present disclosure; and

FIG. 3 is a flowchart illustrating a process for fabricating a quiet gas connector as shown in FIG. 1.

### DETAILED DESCRIPTION OF EXEMPLARY EMBODIMENTS

The present disclosure overcomes many of the prior art problems associated with gas connectors. In general, the gas connector is used for conveying gases such as natural gas, propane, and air to domestic and industrial appliances and decorative elements such as fireplace logs. Among other features and benefits, a gas connector constructed in accordance with the present disclosure has been found to eliminate and/or make undetectable the whistling noises when conveying a gas. The advantages, and other features of the system disclosed herein, will become more readily apparent to those having ordinary skill in the art from the following detailed description of certain exemplary embodiments taken in conjunction with the drawings which set forth representative embodiments of the present disclosure and wherein like reference numerals identify similar structural elements.

All relative descriptions herein such as left, right, up, down, height, thickness and the like are with reference to the Figures, and not meant in a limiting sense. Additionally, the illustrated embodiments can be understood as providing exemplary features of varying detail of certain embodiments, and therefore, features, components, modules, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and can be altered without materially affecting or limiting the disclosed technology.

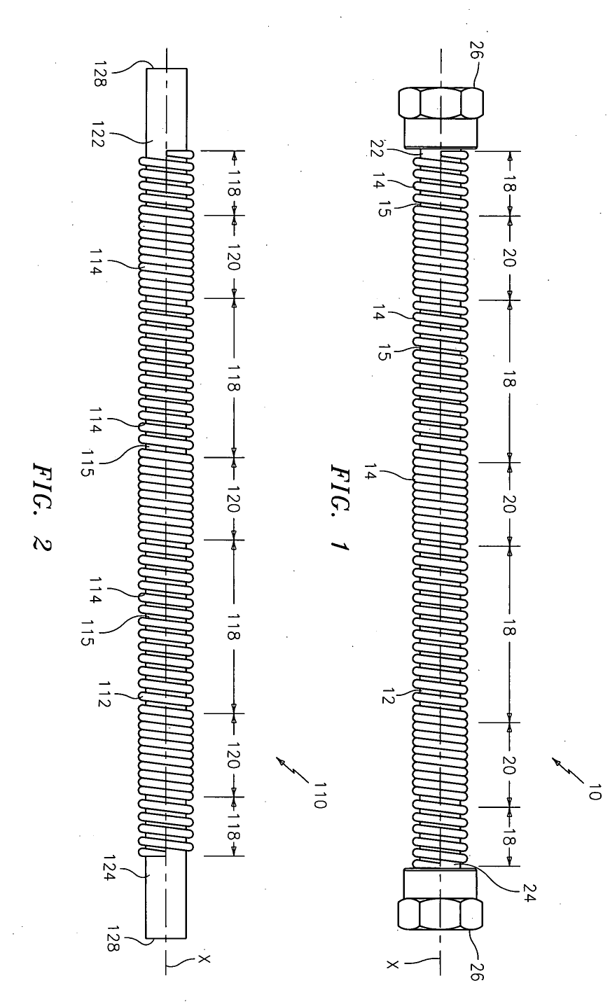

Referring to FIG. 1, a gas connector is shown in side elevation view and referred to generally by the reference numeral 10. The gas connector 10 includes a tube 12 having corrugations 14. For simplicity, only some of the corrugations 14 are labeled on the figures. The corrugations 14 are arranged to form a pattern of successively repeating segments 18 of non-compressed corrugations 14 and segments 20 of compressed corrugation 14. In the exemplary embodiment shown in FIG. 1, all of the corregations 14 are of a uniform height and thickness. In another exemplary embodiment, however, the heights and/or the thicknesses of the corrugations 14 are varied. The corregations 14 are connected together in a single helix. Alternatively, however, separated corregations can be used.

In the embodiment shown, each segment 18, 20 of the tube 12 includes twelve corrugations 14, except the segment 18 adjacent the ends 22, 24 of the tube 12 include four and a half corregations 14. The non-compressed segments 18 having twelve corrugations are relatively longer than the compressed segments 20 due to the non-compression. Each end 22, 24 of the tube 12 is flared and carries a flare nut 26 for connection to an appliance or tube (not shown). One or more compressed or non-compressed corrugations 14 may extend into the flare nuts 26. In the embodiment shown, the compressed segments 20 are compressed so that there is substantially no space between the corrugations 14 (i.e., the corrugations touch one another). Alternatively, a space may be left between each corrugation 14 of the compressed segments 20.

During use, the gas connector 10 may be advantageously flexed because of the corrugations 14. As fluid flows through the gas connector 10, turbulence created in the non-compressed segments 18 is dissipated in the compressed segments 20. As a result, flow eddies are dissipated and noise that would otherwise be generated thereby is eliminated, undetectable or at least reduced.

According to one exemplary embodiment, the gas connector 10, including the flare nuts 26, is created from durable, corrosion-resistant stainless steel. For example, the corrugated tube 12 may be annealed stainless-steel and the flare nuts 26 may be brass or plated steel. Further, all or portions of the gas connector 10 can be coated or painted. For example, the gas connector 10 can be coated with a heavy-duty, antimicrobial, hot-dipped polyvinylchloride (PVC) coating of any desired color. Connectors 10 covered with black and brown heat-resistant coatings and/or paint are particularly suited for use with artificial fireplace logs as aesthetic appearance is important in such applications in addition to performance.

The gas connector 10 may be any size or length. Lengths from 10 to 72 inches are typical. Common inner diameters are ½ or ⅜ inch. Outer diameters are typically slightly larger. The gas connector 10 may also include one or more valves (not shown) at various locations such as attached to a flare nut 26.

Referring now to FIG. 2, another gas connector in accordance with the subject disclosure is shown in side elevation view and referred to generally by the reference numeral 110. As will be appreciated by those of ordinary skill in the pertinent art, the gas connector 110 utilizes similar principles to the gas connector 10 described above. Accordingly, like reference numerals preceded by the numeral “1” are used to indicate like elements. The primary difference of the gas connector 110 in comparison to the gas connector 10 is the inclusion of a straight neck 128 on each end 122, 124 without a flare nut. The necks 128 can serve to engage another component by a compression fit, interference fit and the like as is well known in the art.

Those skilled in the art will readily appreciate however, that the subject disclosure is not limited to a gas connector and may be used in liquid and/or slurry applications as well. The corrugated tube 12, 112 can be formed from various materials including plastic and metal. Exemplary metals include, without limitation, brass, aluminum, steel, and copper with any coating now known or later developed as desired for specific applications.

It is envisioned and well within the scope of the subject disclosure that the entire tube of the connector-does not need to be corrugated. For example, the tube could-have one or more uncorrugated or straight sections. Such sections also disrupt turbulence and make the connector quiet. The turbulence disrupting sections may have inner and/or outer diameters of different sizes from the uncompressed, corrugated sections. The turbulence disrupting sections may be flexible or rigid, and smooth or rough. The connector could also have one or more dimpled and/or angled sections intermediate the uncompressed, corrugated sections that function to disrupt the turbulence and create quiet flow.

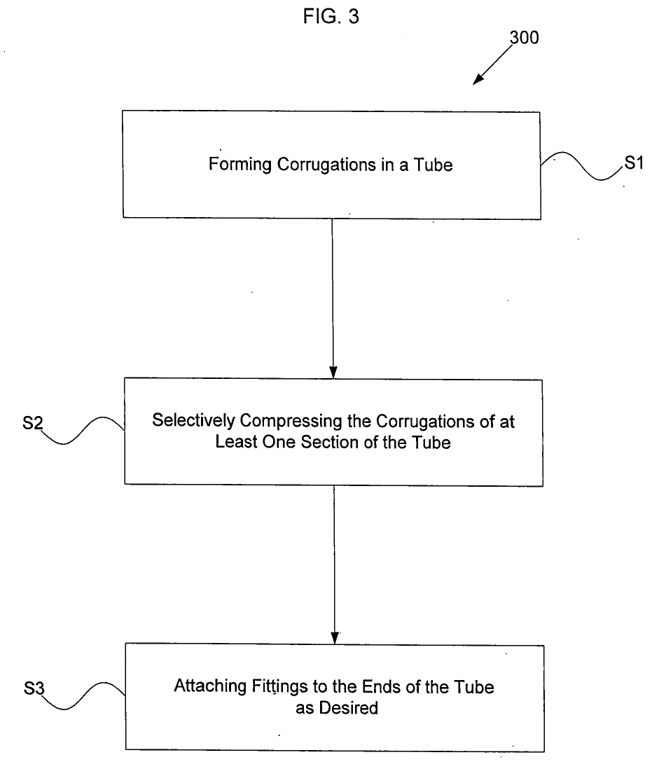

Referring now to FIG. 3, there is illustrated a flowchart 300 depicting a process for fabricating a quiet gas connector as shown in FIG. 1. At step S1 of FIG. 3, corrugations 14 are formed in a length of tube 12 in a well known manner. Initially, the corrugations 14 are uniformly created along the length of the tube 12. In other words, the tube 12 includes no compressed segments.

At step S2, one or more compressed segments 20 are formed in the tube 12. To form the compressed segments 20, a die is sized and configured to engage and compress a plurality of corrugations 114 along the axis x shown in FIG. 1. As such, not just the repeating pattern of non-compressed and compressed equally sized segments 18, 20 may be formed. The configuration of the die or dies could be varied to compress any number of corrugations 14 rather than strictly adhering to the twelve compressed corrugations 14 shown. The compressed segments 20 are compressed so that there is substantially no space between the corrugations 14. Alternatively, a space may be left between each corrugation 14 of the compressed segments 20. It is noted that during compression, the length of the tube 12 is reduced by, for example, about 25%. At step S3, the flare nuts 26 are attached to the ends 22, 24. In another embodiment, the die is used to stretch the corrugations such that the corrugations 14 of the tube 12 are flattened or even substantially elimination.

While the present disclosure has been described with respect to preferred embodiments, those skilled in the art will readily appreciate that various changes and/or modifications can be made to the disclosure without departing from the spirit or scope of the disclosure as defined by the appended claims.

What is claimed is:

1. A quiet connector for conveying fluid comprising:
a tube having a first end and a second end and corrugations, wherein at least one segment of the corrugations is axially compressed to disrupt noise-generating turbulence therein; and
means on each end for coupling the tube in a fluidic system.

2. A quiet connector as recited in claim 1, wherein the at least one segment of axially compressed corrugations includes substantially no spaces between the compressed corrugations.

3. A quiet connector as recited in claim 1, wherein at least one segment of the corrugations of the tube is non-compressed.

4. A quiet connector as recited in claim 3, wherein the non-compressed and the compressed segments include an equal number of corrugations.

5. A quiet connector as recited in claim 3, wherein the the tube includes a repeating pattern of the compressed segment and the non-compressed segment.

6. A quiet connector as recited in claim 1, wherein the corregations are connected in a helix.

7. A quiet connector as recited in claim 1, wherein the corrugations have a uniform height and thickness.

8. A quiet connector as recited in claim 1, wherein the tube includes at least one uncorrugated section intermediate corrugated sections of the tube.

9. A quiet connector as recited in claim 1, wherein the means on each end is selected from the group consisting of a compression neck, a flare nut and combinations thereof.

10. A quiet connector as recited in claim 1, wherein the quiet connector is adapted and configured to convey a fluid selected from the group consisting of natural gas, propane, ambient air, nitrogen, oxygen, argon, helium, a liquid, a slurry and combinations thereof.

11. A flexible fluid connector comprising:
a tube having a plurality of corrugations, wherein the corrugations form successively repeating patterns including a first segment of non-compressed corrugations and a second segment of axially compressed corrugations.

12. A flexible fluid connector as recited in claim 11, wherein the corrugations are of a uniform height and thickness.

13. A flexible fluid connector as recited in claim 11, wherein the non-compressed and compressed segments include an equal number of corrugations.

14. A flexible fluid connector as recited in claim 11, wherein the tube compressed segment includes substantially no spaces between the corrugations.

15. A method for fabricating a quiet gas connector comprising the steps of:
forming corrugations in a length of tube; and
axially modifying a portion of the corrugations using a die.

16. A method as recited in claim 15, further comprising the step of attaching a flare nut to each end of the tube.

17. A method as recited in claim 15, wherein the corrugations are of uniform height and thickness.

18. A method as recited in claim 15, further comprising the step of axially compressing a plurality of segments of the corrugations to form a repeating pattern of non-compressed and compressed segments of corrugations.

19. A method as recited in claim 15, further comprising the step of using a second die to compress a different number of the corrugations.

20. A method as recited in claim 15, wherein each segment is provided with an equal number of corrugations.

21. A quiet connector for conveying fluid comprising:
a tube having a first end and a second end and corrugations, wherein at least one segment of the tube is uncompressed to disrupt noise-generating turbulence therein; and
means on each end for coupling the tube in a fluidic system.
